(19) United States
(12) Patent Application Publication
(10) Pub. No.: US 2012/0038607 A1
(43) Pub. Date: Feb. 16, 2012

(54) ORGANIC LIGHT EMITTING DISPLAY AND METHOD OF DRIVING THE SAME

(75) Inventors: Chul-Kyu KANG, Yongin-City (KR); Yong-Sung Park, Yongin-City (KR); Sang-Moo Choi, Yongin-City (KR); Keum-Nam Kim, Yongin-City (KR)

(73) Assignee: Samsung Mobile Display Co., Ltd., Yongin-city (KR)

(21) Appl. No.: 12/981,078

(22) Filed: Dec. 29, 2010

(30) Foreign Application Priority Data
Aug. 10, 2010 (KR) 10-2010-0076853

(51) Int. Cl. G09G 5/00; G09G 3/30

(52) U.S. Cl. 345/211; 345/76

(57) ABSTRACT

An organic light emitting display includes a pixel unit including pixels coupled to scan lines, control lines, data lines, and first and second power sources, a control line driver for providing control signals to the pixels through the control lines, a scan driver for providing scan signals to the pixels through the scan lines, a data driver for providing data signals to the pixels through data lines, and a first power source driver for applying the first power source to the pixels. The first power source driver sets the first power source as a voltage in a low level in a first period in one frame period. The first power source is set as a high level voltage in second and third periods in one frame period. Therefore, it is possible to compensate for deviation in the threshold voltages generated between the driving transistors included in the pixels.

### CROSS-REFERENCE TO RELATED APPLICATION

This application claims the benefit of Korean Application No. 10-2010-0076853, filed Aug. 10, 2010, in the Korean Intellectual Property Office, the disclosure of which is incorporated herein by reference.

### BACKGROUND

1. Field

Aspects of the present invention relate to an organic light emitting display and a method of driving the same, and more particularly, to an organic light emitting display capable of compensating for deviation in a threshold voltage generated between driving transistors included in pixels to display an image with uniform brightness and a method of driving the same.

2. Description of the Related Art

Recently, various flat panel displays (FPD) having reduced weight and volume compared to cathode ray tubes (CRT) have been developed. The FPDs include liquid crystal displays (LCD), field emission displays (FED), plasma display panels (PDP), and organic light emitting displays.

Among the FPDs, the organic light emitting displays display images using organic light emitting diodes (OLED) that generate light by re-combination of electrons and holes. The organic light emitting display has high response speed and is driven with low power consumption.

In general, the OLED is divided into a passive matrix type OLED (PMOLED) and an active matrix type OLED (AMOLED) according to a method of driving the OLED.

The AMOLED includes a plurality of gate lines, a plurality of data lines, a plurality of power source lines, and a plurality of pixels coupled to the above lines to be arranged in the form of a matrix. In addition, each of the pixels commonly includes an OLED, two transistors, that is, a switching transistor for transmitting a data signal and a driving transistor for driving the organic light emitting diode (OLED) in accordance with the data signal, and a capacitor for maintaining the data voltage.

However, the conventional organic light emitting display may not display an image with uniform brightness by deviation in a threshold voltage.

In detail, the threshold voltages of driving transistors included in pixels, respectively, are different from each other due to a deviation in the manufacturing process. Therefore, although the data signal corresponding to the same gray scale is supplied to a plurality of pixels, since light components with different brightness components are generated by organic light emitting diodes (OLED) due to a difference in the threshold voltage of the driving transistor, brightness becomes non-uniform.

### SUMMARY

Accordingly, an aspect of the present invention has been made to provide an organic light emitting display capable of compensating for deviation in a threshold voltage generated between driving transistors included in pixels to display an image with uniform brightness and a method of driving the same.

In order to achieve the foregoing and/or other aspects of the present invention, there is provided an organic light emitting display, including a pixel unit including pixels coupled to scan lines, control lines, data lines, and first and second power sources, a control line driver for providing control signals to the pixels through the control lines, a scan driver for providing scan signals to the pixels through the scan lines, a data driver for providing data signals to the pixels through data lines, and a first power source driver for applying the first power source to the pixels. The first power source driver sets the first power source as a voltage in a low level in a first period in one frame period and the first power source is set as a high level voltage in second and third periods in one frame period.

According to another aspect of the present invention, the scan driver simultaneously supplies a first scan signal to pixels through the scan lines in the first period.

According to another aspect of the present invention, the scan driver sequentially supplies a second scan signal to the scan lines in the second period.

According to another aspect of the present invention, the control line driver simultaneously supplies control signals to the pixels through the control lines in the first period and the third period.

According to another aspect of the present invention, the data driver simultaneously supplies an initializing voltage to the pixels through the data lines in the first period, supplies data signals to the pixels through the data lines in the second period, and simultaneously supplies a supplementary voltage to the pixels through the data lines in the third period.

According to another aspect of the present invention, each of the pixels includes a first transistor having a first electrode coupled to the first power source, having a second electrode coupled to a second electrode of a second transistor, and having a gate electrode coupled to a first node, a second transistor having a first electrode coupled to the first node, having a second electrode coupled to the second electrode of the first transistor, and having a gate electrode coupled to a scan line, a third transistor having a first electrode coupled to the second electrode of the first transistor, having a second electrode coupled to an anode electrode of an organic light emitting diode (OLED), and having a gate electrode coupled to a control line, an OLED having an anode electrode coupled to a second electrode of the third transistor and having a cathode electrode coupled to the second power source, and a storage capacitor coupled between a data line and the first node.

According to another aspect of the present invention, each of the first to third transistors is either a PMOS transistor or an NMOS transistor.

According to another aspect of the present invention, there is provided a method of driving an organic light emitting display, including simultaneously supplying a first power source, an initializing voltage, a first scan signal, and a control signal having a low level voltage to pixels that constitute a pixel unit so that a voltage corresponding to a difference between an initializing voltage and an anode electrode voltage of an OLED is charged in storage capacitors of pixels, sequentially supplying a second scan signal to the pixels and applying data signals to the pixels, to which the second scan signal is supplied, and simultaneously supplying control signals to the pixels so that the pixels simultaneously emit light with brightness components corresponding to the data signals applied to the pixels.

According to another aspect of the present invention, in sequentially supplying a second scan signal to the pixels and applying data signals to the pixels, to which the second scan signal is supplied and simultaneously supplying control signals to the pixels so that the pixels simultaneously emit light with brightness components corresponding to the data signals applied to the pixels, a first power source having a high level voltage is supplied to the pixel.

According to another aspect of the present invention, in simultaneously supplying control signals to the pixels so that the pixels simultaneously emit light with brightness components corresponding to the data signals applied to the pixels, a supplementary voltage is supplied to the pixels.

According to another aspect of the present invention, in sequentially supplying a second scan signal to the pixels and applying data signals to the pixels, to which the second scan signal is supplied, a voltage corresponding to a difference between the first power source and a threshold voltage of a first transistor is applied to a gate electrode of the first transistor included in each of the pixels.

As described above, according to an aspect of the present invention, deviation in the threshold voltages of the driving transistors included in the pixels may be compensated for without power swing so that the organic light emitting display that displays an image with uniform brightness and the method of driving the same may be provided.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a view illustrating an organic light emitting display according to an embodiment of the present invention;

FIG. 2 is a view illustrating a pixel according to an embodiment of the present invention;

FIG. 3 is a waveform chart illustrating a method of driving the pixel of FIG. 2; and

FIG. 4 is a view illustrating a pixel according to another embodiment of the present invention.

### DETAILED DESCRIPTION

Reference will now be made in detail to the present embodiments of the present invention, examples of which are illustrated in the accompanying drawings, wherein like reference numerals refer to the like elements throughout. The embodiments are described below in order to explain the present invention by referring to the figures.

Detailed items of the other embodiments are included in detailed description and drawings. The advantages and/or characteristics of the aspects of the present invention and a method of achieving the advantages and/or characteristics of the aspects of the present invention now will be described more fully with reference to the accompanying drawings, in which exemplary embodiments of the invention are shown. This invention may, however, be embodied in many different forms and should not be construed as being limited to the embodiments set forth herein. In the drawings, when a part is coupled to another part, the part may be directly coupled to another part and the part may be electrically coupled to another part with another element interposed. In the drawings, the part that is not related to the present invention is omitted for clarity of description. The same reference numerals in different drawings represent the same element, and thus their description will be omitted.

Hereinafter, the aspects of the present invention will be described with reference to drawings for describing an organic light emitting display and a method of driving the same according to the embodiments of the aspects of the present invention.

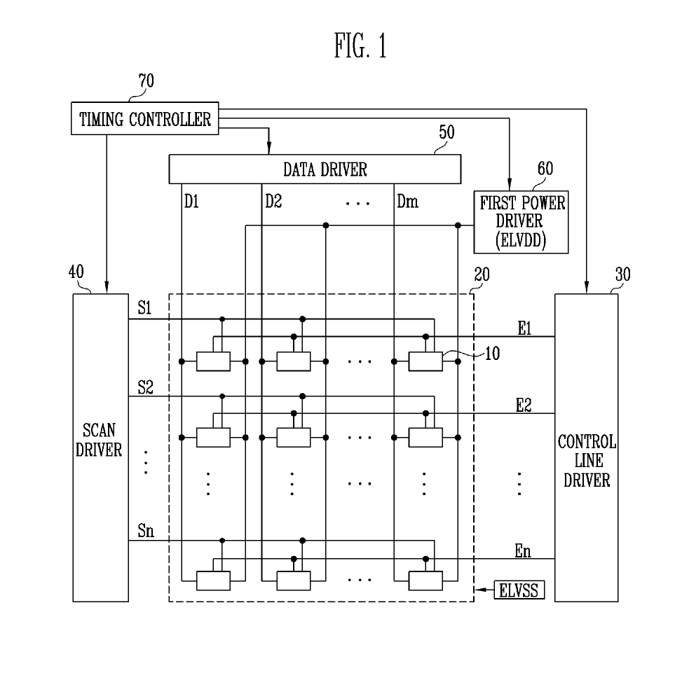

FIG. 1 is a view illustrating an organic light emitting display according to an embodiment of the present invention. Referring to FIG. 1, the organic light emitting display includes a pixel unit 20 including pixels 10 coupled to scan lines S1 to Sn, control lines E1 to En, data lines D1 to Dm, and a first power source ELVDD and a second power source ELVSS, a control line driver 30 for supplying control signals to the pixels 10 through the control lines E1 to En, a scan driver 40 for supplying scan signals to the pixels 10 through the scan lines S1 to Sn, a data driver 50 for supplying data signals to the pixels 10 through data lines D1 to Dm, and a first power source driver 60 for applying the first power source ELVDD to the pixels 10 and may further include a timing controller 70 for controlling the control line driver 30, the scan driver 40, the data driver 50, and the first power source driver 60.

The pixels 10 are coupled to the first power source ELVDD and the second power source ELVSS. The pixels 10 that received the first power source ELVDD and the second power source ELVSS generate light components corresponding the data signals by the current that flows from the first power source ELVDD to the second power source ELVSS via an organic light emitting diode (OLED).

The first power source driver 60 supplies the first power source ELVDD to the pixels and changes the voltage of the first power source ELVDD by a specific period by the control of the timing controller 70.

That is, the first power source driver 60 sets the voltage of the first power source ELVDD to a low level voltage that is low enough so that the OLEDs included in the pixels 10 may not emit light in a first period in one frame period. In second and third periods in one frame period, the voltage of the first power source ELVDD is changed into a high level voltage, by which the OLEDs included in the pixels 10 may emit light, and the high level voltage is maintained.

Meanwhile the voltage of the first power source ELVDD is changed into low and high levels, the second power source ELVSS is uniformly maintained as a low level voltage (for example, Ground) in one frame.

The control line driver 30 generates the control signals by the control of the timing controller 70 and simultaneously supplies the generated control signals to the control lines E1 to En.

The control line driver 30 simultaneously supplies the control signals for turning on transistors to the pixels 10 through the emission control lines E1 to En in the first and third periods.

In FIG. 1, the control line driver 30 is separate from the scan driver 40, however the control line driver 30 may be included in the scan driver 40.

The scan driver 40 generates the scan signals by the control of the timing controller 70 and simultaneously and sequentially supplies the generated scan signals to the scan lines S1 to Sn.

In particular, the scan driver 40 supplies scan signals twice to the scan lines S1 to Sn in one frame. The scan signal supplied first in one frame is defined as a first scan signal and the scan signal supplied second is defined as a second scan signal. The supply period of the first scan signal may be longer than the supply period of the second scan signal.

In addition, the first scan signal is simultaneously supplied to the pixels 10 through the scan lines S1 to Sn in the first period, however, the second scan signal is sequentially supplied from the first scan line S1 to the nth scan line Sn in the second period to be applied to the pixels 10.

The data driver 50 generates the data signals for determining the emission brightness of the pixels by the control of the timing controller 70 and supplies the generated data signals to the data lines D1 to Dm.

In addition, the data driver 50 simultaneously supplies an initializing signal V0 to the data lines D1 to Dm in the first period where the first scan signal is supplied in order to initialize the voltage of the pixels 10.

In order to write data, the data signals are supplied to the pixels 10 that receive the second scan signal in the second period where the second scan signal is sequentially supplied to the scan lines S1 to Sn in order to write data.

In addition, in the third period where the control signals are supplied to the pixels 10, a supplementary voltage Vsus is simultaneously supplied to the data lines D1 to Dm so that the supplementary voltage Vsus is simultaneously supplied to the pixels 10.

The initializing voltage V0 supplied by the data driver 50 may be a high level voltage and the supplementary voltage Vsus may be a low level voltage.

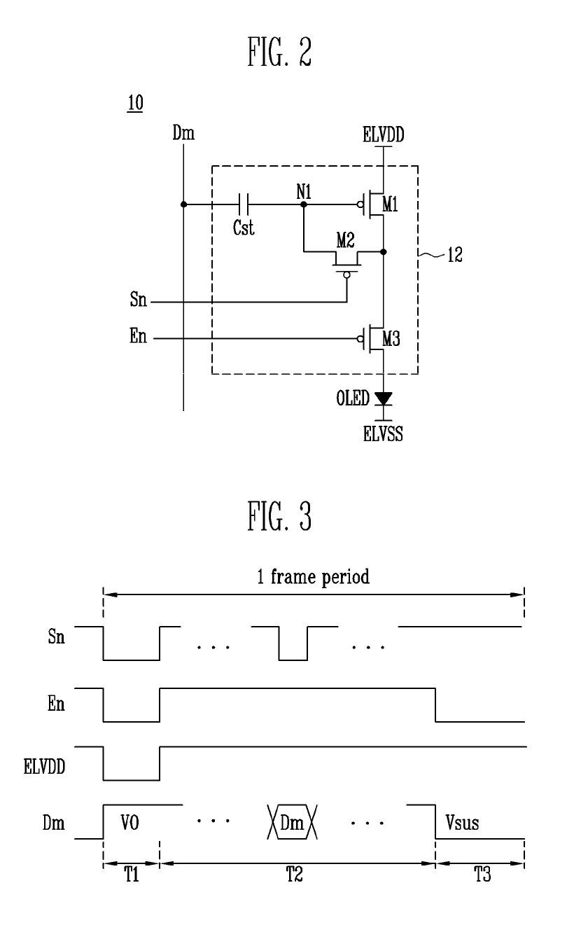

FIG. 2 is a view illustrating a pixel according to an embodiment of the present invention. In FIG. 2, for convenience sake, the pixel 10 coupled to the nth scan line Sn and the mth data line Dm will be illustrated.

Referring to FIG. 2, each of the pixels 10 includes a pixel circuit 12 coupled to the OLED, the data line Dm, and the scan line Sn to control the amount of current supplied to the OLED.

The anode electrode of the OLED is coupled to the pixel circuit 12 and the cathode electrode of the OLED is coupled to the second power source ELVSS. The OLED generates light with predetermined brightness to correspond to the current supplied from the pixel circuit 12.

The pixel circuit 12 controls the current that flows from the first power source ELVDD to the second power source ELVSS via the OLED to correspond to the data signal supplied to the data line Dm when a scans signal is supplied to the scan line Sn.

Therefore, the pixel circuit 12 includes first to third transistors M1 to M3 and a storage capacitor Cst.

The first transistor M1 as a driving transistor generates the current corresponding to a voltage between a gate electrode and a first electrode to supply the current to the OLED. Therefore, the first electrode of the first transistor M1 is coupled to the first power source ELVDD, the second electrode of the first transistor M1 is coupled to the second electrode of the second transistor M2, and the gate electrode of the first transistor M1 is coupled to the first node N1.

The first electrode of the second transistor M2 is coupled to the first node N1, the second electrode of the second transistor M2 is coupled to the second electrode of the first transistor M1, and the gate electrode of the second transistor M2 is coupled to the scan line Sn. The second transistor M2 is turned on when the first scan signal or the second scan signal is supplied from the scan line Sn to electrically couple the first node N1 and the second electrode of the first transistor M1 to each other.

The scan signals including the first scan signal and the second scan signal turn on the second transistor M2. As illustrated in FIG. 2, when the second transistor M2 is a PMOS transistor, the voltage of the scan signals is in a low level. When the second transistor M2 is an NMOS transistor, the voltage of the scan signals is in a high level.

The first electrode of the third transistor M3 is coupled to the second electrode of the first transistor M1. The second electrode of the third transistor M3 is coupled to the anode electrode of the OLED. The gate electrode of the third transistor M3 is coupled to the control line En. The third transistor M3 is turned on when the control signals are supplied from the control line En to electrically couple the second electrode of the first transistor M1 to the anode electrode of the OLED.

The control signals turn on the third transistor M3. As illustrated in FIG. 2, when the third transistor M3 is the PMOS transistor, the voltage of the control signals is in a low level. When the third transistor M3 is the NMOS transistor, the voltage is in a high level.

One terminal of the storage capacitor Cst is coupled to the data line Dm and the other terminal of the storage capacitor Cst is coupled to the first node N1.

The anode electrode of the OLED is coupled to the second electrode of the third transistor M3 and the cathode electrode of the OLED is coupled to the second power source ELVSS to generate the light corresponding to the driving current generated by the first transistor M1.

The first node N1 is a contact point where the gate electrode of the first transistor M1, the other terminal of the storage capacitor Cst, and the first electrode of the second transistor M2 are simultaneously coupled to each other.

The above-described first to third transistors M1 to M3 may be PMOS transistors as illustrated in FIG. 2 and/or may be NMOS transistors.

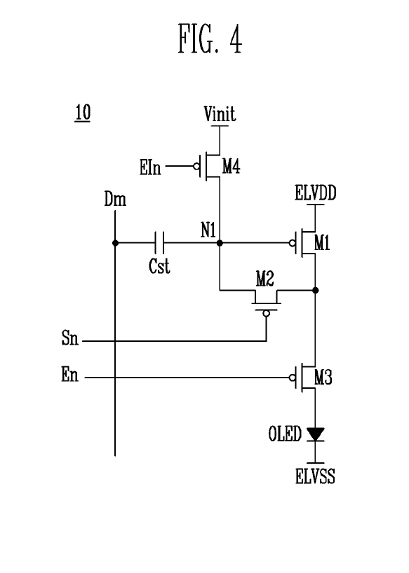

FIG. 3 is a waveform chart illustrating a method of driving the pixel of FIG. 2. Hereinafter, the operation of the organic light emitting display according to the driving method of an aspect of the present invention will be described with reference to FIGS. 2 and 3.

The driving of the organic light emitting display consists of an initializing period T1 for initializing the voltages of the storage capacitors Cst of the pixels 10, a data writing period T2, in which the data signals are supplied to the data lines so that the data signals are applied to the pixels 10, and the emission period T3, in which the pixels simultaneously emit light with brightness components corresponding to the voltages charged in the pixels 10.

First, in the initializing period T1, the first scan signal is supplied to the scan line Sn and the control signals are supplied to the control line En.

In addition, the voltage of the first power source ELVDD supplied to the pixels 10 in the initializing period T1 is set to be in a low level and the initializing voltage V0 is supplied to the data line Dm to be applied to one terminal of the storage capacitor Cst.

Due to the first scan signal and the control signal, the second transistor M2 and the third transistor M3 are turned off in the initializing period T1.

As the second transistor M2 and the third transistor M3 are turned off, the anode electrode voltage of the OLED in an off state is applied to the first node N1.

Therefore, since the initializing voltage V0 is applied to one terminal of the storage capacitor Cst and the anode electrode voltage of the OLED is applied to the other terminal of the storage capacitor Cst, the voltage corresponding to a difference between the initializing voltage V0 and the anode electrode voltage of the OLED is charged in the storage capacitor Cst.

In the above, only one pixel was described. However, since the first scan signal and the control signal are simultaneously supplied to the pixels 10 included in the pixel unit 20, the storage capacitors Cst of the pixels 10 are charged by the voltage corresponding to a difference between the initializing signal V0 and the anode electrode voltage of the OLED in the initializing period T1. The supply of the first scan signal and the control signal is stopped and the period enters into the data writing period T2 that is the second period in the one frame period.

In the data writing period T2, the second scan signal is supplied to the scan line Sn and the data signal is supplied to the data line Dm to correspond to the second scan signal.

In addition, the voltage of the first power source ELVDD supplied to the pixels 10 in the data writing period T2 is changed into a high level voltage.

The second transistor M2 is turned on by the second scan signal and electrically couples the first node N1 to the second electrode of the first transistor M1.

At this time, the supply of the control signals is stopped in order to block the current that flows to the OLED so that the third transistor M3 is turned off in the data writing period T2.

As s result, the data signal is applied to one terminal of the storage capacitor Cst and the voltage corresponding to a difference between the first power source ELVDD and the threshold voltage Vth1 of the first transistor M1 is applied to the other terminal of the storage capacitor Cst.

Therefore, when the voltage of the first node N1 is referred to VN1, VN1=ELVDD_d−Vth1 is established (ELVDD_d is the voltage of the first power source ELVDD in the data writing period T2).

In the above, only one pixel was described. Since the second scan signal is sequentially supplied to the scan lines S1 to Sn, the voltage of [ELVDD_d−Vth1] is applied to the first nodes N1 of the pixels 10.

Then, since the control signal is supplied through the control line En, the period enters into the emission period T3 that is a third period in one frame period.

The control signals are supplied in the emission period T3 and the voltage of the first power source ELVDD supplied to the pixels 10 is set to be in a high level.

The voltage of the first power source ELVDD is maintained at a high level voltage which is the same as the voltage supplied in the data writing period T2.

In addition, in the emission period T3, the supplementary voltage Vsus is supplied to the data line Dm in the emission period T3.

The third transistor M3 is turned on by the control signal so that the OLED emits light in the emission period T3. However, the second transistor is turned off in order to block coupling between the first node N1 and the second electrode of the first transistor M1.

As the data signal supplied to the data line Dm is changed into the supplementary voltage Vsus in the emission period T3, the voltage VN1 of the first node N1 is changed into [ELVDD_d−Vth1−(Vdata−Vsus)] (Vdata is the voltage of the data signal).

Therefore, the driving current I generated by the first transistor M1 may be represented as the following equation.

I=β{ELVDD_{—}e−ELVDD_{—}d+Vth1+Vdata−Vsus}−Vth1}²

As a result, in the driving current I, the threshold voltage Vth1 is removed so that the pixels are not affected by deviation in the threshold voltage Vth1 so that an image with uniform brightness may be displayed.

As illustrated in FIG. 3, when the voltage ELVDD_d of the first power source ELVDD in the data writing period T2 is the same as the voltage ELVDD_e of the first power source ELVDD in the emission period T3, the driving current I may be represented as I=β{Vdata−Vsus}².

Since the control signal is simultaneously supplied to the pixels 10 included in the pixel unit 20, the driving current I flows to the OLED of the pixels 10 and the OLED generates the light corresponding to the driving current I so that the pixels 10 simultaneously emit light.

In the emission period T3, as the first scan signal is simultaneously supplied to the pixels 10, the period enters into the initializing period T1 and the above-described data writing period T2 and emission period T3 are repeated.

FIG. 4 is a view illustrating a pixel according to another embodiment of the present invention. Referring to FIG. 4, the illustrated pixel in addition to having the features of the pixel illustrated in FIG. 3 includes a fourth transistor M4, the initializing power source Vinit, and the second control line Eln.

The first electrode of the fourth transistor M4 is coupled to the initializing power source Vinit, the second electrode of the fourth transistor M4 is coupled to the first node N1, and the gate electrode of the fourth transistor M4 is coupled to the second control line Eln.

In the embodiment illustrated in FIG. 3, in order to initialize the storage capacitor Cst, in the initializing period T1, the second transistor M2 and the third transistor M3 are turned on to apply the anode electrode voltage of the OLED to the first node N1.

However, since the additional initializing power source Vinit is provided in the other embodiment, although the second transistor M2 and the third transistor M3 are not turned on in the initializing period T1, the second control signal for turning on the fourth transistor M4 to the second control line Eln is supplied to apply the initializing power source Vinit to the first node N1.

Therefore, since it is not necessary to turn on the second transistor M2 and the third transistor M3 in the initializing period T1, it is not necessary to change the first power source ELVDD into a voltage in a low level.

Since the remaining elements of the embodiment of FIG. 4 are the same as those of the embodiment of FIG. 3, detailed description will be omitted.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. An organic light emitting display, comprising:
a pixel unit including pixels coupled to scan lines, control lines, data lines, and first and second power sources;
a control line driver to provide control signals to the pixels through the control lines;
a scan driver to provide scan signals to the pixels through the scan lines;
a data driver to provide data signals to the pixels through data lines; and
a first power source driver to apply the first power source to the pixels,
wherein the first power source driver sets the first power source as a voltage in a low level in a first period in one frame period, and
wherein the first power source is set as a high level voltage in second and third periods in the one frame period.

2. The organic light emitting display as claimed in claim 1, wherein the scan driver simultaneously supplies a first scan signal to the pixels through the scan lines in the first period.

3. The organic light emitting display as claimed in claim 2, wherein the scan driver sequentially supplies a second scan signal to the scan lines in the second period.

4. The organic light emitting display as claimed in claim 1, wherein the control line driver simultaneously supplies control signals to the pixels through the control lines in the first period and the third period.

5. The organic light emitting display as claimed in claim 1, wherein the data driver simultaneously supplies an initializing voltage to the pixels through the data lines in the first period, supplies data signals to the pixels through the data lines in the second period, and simultaneously supplies a supplementary voltage to the pixels through the data lines in the third period.

6. The organic light emitting display as claimed in claim 1, wherein each of the pixels comprises:
a first transistor having a first electrode coupled to the first power source, having a second electrode coupled to a second electrode of a second transistor, and having a gate electrode coupled to a first node;
a second transistor having a first electrode coupled to the first node, having a second electrode coupled to the second electrode of the first transistor, and having a gate electrode coupled to one of the scan lines;
a third transistor having a first electrode coupled to the second electrode of the first transistor, and having a gate electrode coupled to one of the control lines;
an organic light emitting diode (OLED) having an anode electrode coupled to a second electrode of the third transistor and having a cathode electrode coupled to the second power source; and
a storage capacitor coupled between one of the data lines and the first node.

7. The organic light emitting display as claimed in claim 6, wherein each of the first to third transistors is either a PMOS transistor or an NMOS transistor.

8. A method of driving an organic light emitting display, comprising:
simultaneously supplying a first power source, an initializing voltage, a first scan signal, and a control signal having a low level voltage to pixels that constitute a pixel unit so that a voltage corresponding to a difference between an initializing voltage and an anode electrode voltage of an organic light emitting diode (OLED) is charged in storage capacitors of each of the pixels;
sequentially supplying a second scan signal to each of the pixels and applying data signals to each of the pixels, to which the second scan signal is supplied; and
simultaneously supplying control signals to each of the pixels so that each of the pixels simultaneously emit light with brightness components corresponding to the data signals applied to each of the pixels.

9. The method as claimed in claim 8, wherein, in sequentially supplying the second scan signal to each of the pixels and applying the data signals to each of the pixels, to which the second scan signal is supplied and simultaneously supplying the control signals to each of the pixels so that each of the pixels simultaneously emit light with brightness components corresponding to the data signals applied to each of the pixels, a first power source having a high level voltage is supplied to each of the pixels.

10. The method as claimed in claim 8, wherein, in simultaneously supplying the control signals to each of the pixels so that each of the pixels simultaneously emit light with brightness components corresponding to the data signals applied to each of the pixels, a supplementary voltage is supplied to each of the pixels.

11. The method as claimed in claim 9, wherein, in sequentially supplying the second scan signal to each of the pixels and applying the data signals to each of the pixels, to which the second scan signal is supplied, a voltage corresponding to a difference between the first power source and a threshold voltage of a first transistor is applied to the gate electrode of the first transistor included in each of the pixels.
